(19) United States
(12) Patent Application Publication
(10) Pub. No.: US 2010/0207926 A1
(43) Pub. Date: Aug. 19, 2010

(54) METHOD OF DRIVING PLASMA DISPLAY PANEL

(76) Inventors: Mukhee Kim, Gumi (KR); Junho Park, Gumi (KR); Kisoo Ha, Gumi (KR); Sangyoon Soh, Gumi (KR)

Correspondence Address: BIRCH STEWART KOLASCH & BIRCH, PO BOX 747, FALLS CHURCH, VA, 22040-0747, US

(21) Appl. No.: 12/738,746

(22) PCT Filed: Dec. 12, 2008
(86) PCT No.: PCT/KR08/07363

§ 371 Date: Apr. 19, 2010

(30) Foreign Application Priority Data
Dec. 26, 2007 (KR) 10-2007-0137440

(51) Int. Cl. G09G 3/28

(52) U.S. Cl. 345/212; 345/60

(57) ABSTRACT

A method of driving a plasma display panel including a scan electrode and a sustain electrode positioned substantially parallel to each other and an address electrode crossing the scan electrode and the sustain electrode is provided. The method includes supplying a first reset signal to the scan electrode during a reset period of at least one of a plurality of subfields of a frame, and supplying a second reset signal following the first reset signal to the scan electrode. The first and second reset signals each include a rising signal with a gradually rising voltage and a falling signal with a gradually falling voltage. The number of falling signals of the first reset signal is different from the number of falling signals of the second reset signal.

### TECHNICAL FIELD

Embodiments relate to a method of driving a plasma display panel.

### BACKGROUND ART

A plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

### DISCLOSURE OF INVENTION

### Brief Description of the Drawings

FIG. 1 illustrates a configuration of a plasma display apparatus according to an exemplary embodiment;

FIG. 2 illustrates a structure of a plasma display panel according to an exemplary embodiment;

FIG. 3 illustrates a frame for achieving a gray level of an image;

FIG. 4 illustrates a method of driving a plasma display panel according to an exemplary embodiment;

FIG. 5 illustrates configurations of first and second reset signals;

FIG. 6 illustrates minimum voltages of falling signals of first and second reset signals;

FIG. 7 illustrates a configuration of a falling signal;

FIG. 8 illustrates a method of driving a plasma display panel according to an exemplary embodiment;

FIG. 9 is a diagram for explaining a reason why a sustain period is omitted in a first subfield;

FIG. 10 shows that a sustain signal is not supplied to one of a scan electrode and a sustain electrode during a sustain period;

FIG. 11 is a diagram for comparing first, second, and third reset signals; and

FIG. 12 shows that a maximum voltage of a second reset signal is greater than a maximum voltage of a first reset signal.

### MODE FOR THE INVENTION

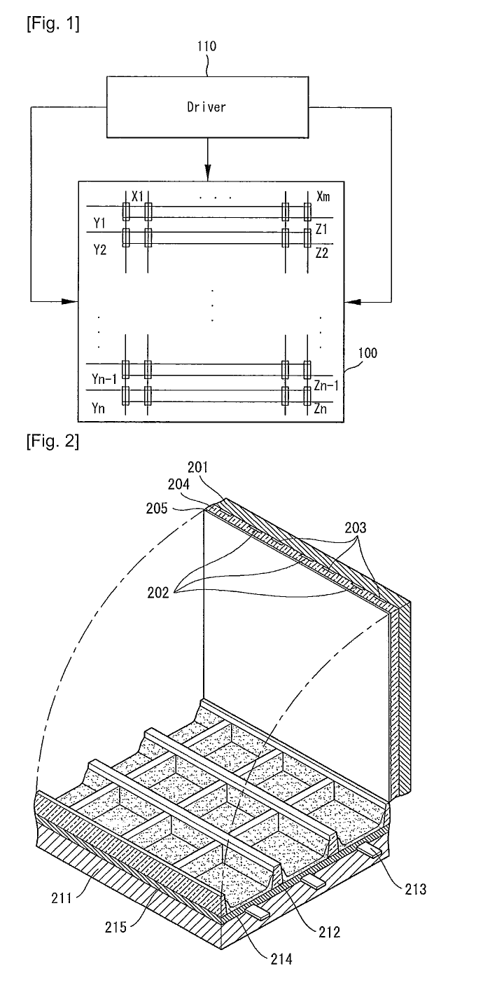

FIG. 1 illustrates a configuration of a plasma display apparatus according to an exemplary embodiment.

As shown in FIG. 1, the plasma display apparatus according to the exemplary embodiment includes a plasma display panel 100 and a driver 110.

The plasma display panel 100 may include scan electrodes Y1 to Yn and sustain electrodes Z1 to Zn positioned substantially parallel to each other and address electrodes X1 to Xm crossing the scan electrodes Y1 to Yn and the sustain electrodes Z1 to Zn.

The driver 110 may supply driving signals to at least one of the scan electrodes Y1 to Yn, the sustain electrodes Z1 to Zn, or the address electrodes X1 to Xm to thereby display an image on the screen of the plasma display panel 100. The driver 110 may supply first and second reset signals to the scan electrode during a reset period of at least one of a plurality of subfields of a frame. The driver 110 may allow the number of falling signals included in the first reset signal to be different from the number of falling signals included in the second reset signal.

Although FIG. 1 shows the driver 110 formed in the form of a signal board, the driver 110 may be formed in the form of a plurality of boards depending on the electrodes on the plasma display panel 100. For example, the driver 110 may include a first driver (not shown) for driving the scan electrodes Y1 to Yn, a second driver (not shown) for driving the sustain electrodes Z1 to Zn, and a third driver (not shown) for driving the address electrodes X1 to Xm.

FIG. 2 illustrates a structure of a plasma display panel according to an exemplary embodiment.

As shown in FIG. 2, the plasma display panel may include a front substrate 201, on which a scan electrode 202 and a sustain electrode 203 are formed substantially parallel to each other and a rear substrate 211 on which an address electrode 213 is foamed to cross the scan electrode 202 and the sustain electrode 203.

An upper dielectric layer 204 may be formed on the scan electrode 202 and the sustain electrode 203 to limit a discharge current of the scan electrode 202 and the sustain electrode 203 and to provide insulation between the scan electrode 202 and the sustain electrode 203.

A protective layer 205 may be formed on the upper dielectric layer 204 to facilitate discharge conditions. The protective layer 205 may be formed of a material having a high secondary electron emission coefficient, for example, magnesium oxide (MgO).

A lower dielectric layer 215 may be formed on the address electrode 213 to provide insulation between the address electrodes 213.

Barrier ribs 212 of a stripe type, a well type, a delta type, a honeycomb type, etc. may be formed on the lower dielectric layer 215 to partition discharge spaces (i.e., discharge cells). Hence, a first discharge cell emitting red light, a second discharge cell emitting blue light, and a third discharge cell emitting green light, etc. may be formed between the front substrate 201 and the rear substrate 211.

The barrier rib 212 may have various structures as well as the structure shown in FIG. 2. For example, the barrier rib 212 may include first and second barrier ribs crossing each other. The barrier rib 212 may have a differential structure in which heights of the first and second barrier ribs are different from each other, a channel structure in which a channel usable as an exhaust path is formed on at least one of the first barrier rib or the second barrier rib, a hollow structure in which a hollow is formed on at least one of the first barrier rib or the second barrier rib, etc.

Each of the discharge cells partitioned by the barrier ribs 212 may be filled with a discharge gas. The discharge gas may include xenon (Xe) and neon (Ne). The discharge gas may further include at least one of argon (Ar) and helium (Hc).

A phosphor layer 214 may be formed inside the discharge cells to emit visible light for an image display during an address discharge. For example, first, second, and third phosphor layers that respectively produce red, blue, and green light may be formed inside the discharge cells.

FIG. 2 shows that the upper dielectric layer 204 and the lower dielectric layer 215 each have a single-layered structure. However, at least one of the upper dielectric layer 204 and the lower dielectric layer 215 may have a multi-layered structure.

A black layer (not shown) capable of absorbing external light may be further formed on the barrier rib 212 so as to prevent the external light from being reflected by the barrier rib 212. Further, another black layer (not shown) may be further formed at a predetermined location of the front substrate 201 corresponding to the barrier rib 212.

While the address electrode 213 may have a substantially constant width or thickness, a width or thickness of the address electrode 213 inside the discharge cell may be different from a width or thickness of the address electrode 213 outside the discharge cell. For example, a width or thickness of the address electrode 213 inside the discharge cell may be greater than a width or thickness of the address electrode 213 outside the discharge cell.

When a predetermined signal is supplied to at least one of the scan electrode 202, the sustain electrode 203, and the address electrode 213, a discharge may occur inside the discharge cells. The discharge may allow the discharge gas filled in the discharge cells to generate ultraviolet rays. The ultraviolet rays may be irradiated on phosphor particles of the phosphor layer 214, and then the phosphor particles may emit visible light. Hence, an image may be displayed on the screen of the plasma display panel.

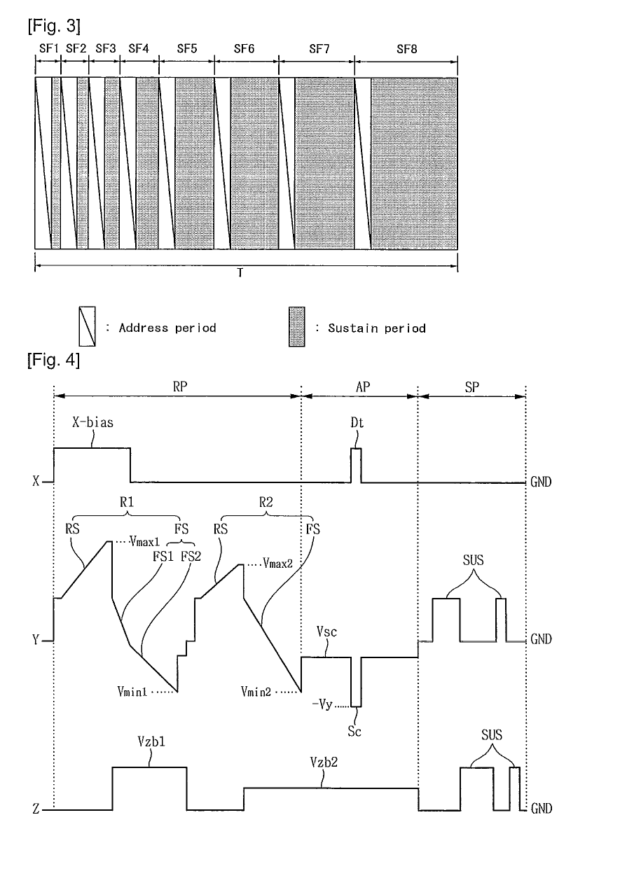

FIG. 3 illustrates a frame for achieving a gray level of an image.

As shown in FIG. 3, a frame may include a plurality of subfields. Each of the plurality of subfields may be divided into an address period and a sustain period. During the address period, the discharge cells not to generate a discharge may be selected or the discharge cells to generate a discharge may be selected. During the sustain period, gray levels may be achieved depending on the number of discharges.

For example, if an image with 256-gray levels is to be displayed, as shown in FIG. 3, a frame may be divided into 8 subfields SF1 to SF8. Each of the 8 subfields SF1 to SF8 may include an address period and a sustain period.

At least one of the plurality of subfields of the frame may further include a reset period for initialization.

At least one of the plurality of subfields of the frame may not include the sustain period.

The number of sustain signals supplied during the sustain period may determine a gray level of each of the subfields. For example, in such a method of setting a gray level of a first subfield at 2⁰ and a gray level of a second subfield at 2¹, the sustain period increases in a ratio of 2ⁿ (where, n=0, 1, 2, 3, 4, 5, 6, 7) in each of the subfields. Hence, various gray levels of an image may be achieved by controlling the number of sustain signals supplied during the sustain period of each subfield depending on a gray level of each subfield.

Although FIG. 3 shows the frame including 8 subfields, the number of subfields constituting a frame may vary. For example, a frame may include 10 or 12 subfields. Further, although FIG. 3 shows the subfields of the frame arranged in increasing order of gray level weight, the subfields may be arranged in decreasing order of gray level weight, or may be arranged regardless of gray level weight.

At least one of a plurality of subfields of a frame may be a selective erase subfield, and at least one of the other subfields may be a selective write subfield.

If a frame includes at least one selective erase subfield and at least one selective write subfield, it may be preferable that a first subfield of a plurality of subfields of the frame is a selective write subfield and the other subfields are selective erase subfields. Alternately, all the subfields of the frame may be selective erase subfields.

In the selective erase subfield, the discharge cells to which a data signal is supplied during an address period are turned off during a sustain period following the address period. In the selective write subfield, the discharge cells to which a data signal is supplied during an address period are turned on during a sustain period following the address period.

FIG. 4 illustrates a method of driving a plasma display panel according to an exemplary embodiment.

As shown in FIG. 4, during a reset period RP for initialization of at least one of a plurality of subfields of a frame, a first reset signal R1 and a second reset signal R2 may be supplied to the scan electrode Y. The second reset signal R2 follows the first reset signal R1.

Each of the first and second reset signals R1 and R2 may include a rising signal RS with a gradually rising voltage and a falling signal FS with a gradually falling voltage.

When the rising signal RS of the first reset signal R1 is supplied to the scan electrode Y, a weak dark discharge (i.e., a setup discharge) occurs inside the discharge cells. Hence, wall charges may be uniformly distributed inside the discharge cells.

After the supply of the rising signal RS, when the falling signal FS of the first reset signal R1 is supplied to the scan electrode Y, a weak erase discharge (i.e., a set-down discharge) occurs inside the discharge cells. Hence, the remaining wall charges are uniformly distributed inside the discharge cells to the extent that an address discharge may stably occur inside the discharge cells.

Subsequently, when the rising signal RS of the second reset signal R2 is supplied to the scan electrode Y, a setup discharge again occurs inside the discharge cells. Then, when the falling signal FS of the second reset signal R2 is supplied to the scan electrode Y, a set-down discharge again occurs inside the discharge cells. Hence, an initialization operation may be performed more efficiently.

A maximum voltage Vmax1 of the first reset signal R1 may be greater than a maximum voltage Vmax2 of the second reset signal R2. Therefore, an intensity of the setup discharge generated by the first reset signal R1 may be greater than an intensity of the setup discharge generated by the second reset signal R2. Hence, an initialization operation may be performed more efficiently.

Each of the first and second reset signals R1 and R2 may include at least one falling signal. The number of falling signals of the first reset signal R1 may be different from the number of falling signals of the second reset signal R2. For example, FIG. 4 shows the first reset signal R1 including first and second falling signals FS1 and FS1 and the second reset signal R2 including only one falling signal FS.

If a maximum voltage of one reset signal of the first and second reset signals R1 and R2 is greater than a maximum voltage of the other reset signal, the number of falling signals of the one reset signal may be more than the number of falling signals of the other reset signal. For example, FIG. 4 shows that a maximum voltage Vmax1 of the first reset signal R1 is greater than a maximum voltage Vmax2 of the second reset signal R2 and the number of falling signals of the first reset signal R1 is more than the number of falling signals of the second reset signal R2. On the contrary, if a maximum voltage of the second reset signal R2 is greater than a maximum voltage of the first reset signal R1, the number of falling signals of the second reset signal R2 may be more than the number of falling signals of the first reset signal R1.

A reset signal may include a plurality of falling signals each having a different voltage change rate. The number of falling signals may be determined depending on whether or not a voltage change rate of a falling signal varies. For example, if a voltage change rate of a reset signal which gradually falls over time varies once, the reset signal may include two falling signals.

As shown in FIG. 4, when the number of falling signals of the first reset signal R1 is more than the number of falling signals of the second reset signal R2, the set-down discharge generated by the falling signals of the first reset signal R1 may be further stabilized. Further, because an intensity of a set-down discharge generated by the falling signals of the first reset signal R1 may be prevented from excessively increasing, contrast characteristics may be improved.

More specifically, if a maximum voltage Vmax1 of the first reset signal R1 is greater than a maximum voltage Vmax2 of the second reset signal R2, the amount of wall charges accumulated inside the discharge cells by the rising signal RS of the first reset signal R1 may be more than the amount of wall charges accumulated inside the discharge cells by the rising signal RS of the second reset signal R2. In this case, if the number of falling signals of the first reset signal R1 is substantially equal to the number of falling signals of the second reset signal R2, an intensity of a set-down discharge generated by the falling signal of the first reset signal R1 may be excessively stronger than an intensity of a set-down discharge generated by the falling signal of the second reset signal R2. As a result, the amount of light generated during the reset period may increase, and the contrast characteristics may worsen.

On the contrary, if the first reset signal R1 includes the first and second falling signals FS1 and FS2 and a voltage change rate of the first falling signal FS1 is greater than a voltage change rate of the second falling signal FS2, a voltage level of the scan electrode Y may sufficiently rapidly fall until a set-down discharge starts to occurs, and the voltage level of the scan electrode Y may relatively slowly fall during generation of the set-down discharge. Therefore, a pulse width of the first reset signal may be prevented from excessively widening, and the intensity of the set-down discharge may be prevented from excessively increasing.

A voltage level of the address electrode X during the supply of the rising signal RS of the first reset signal R1 to the scan electrode Y may be greater than a voltage level of the address electrode X during the supply of the rising signal RS of the second reset signal R2 to the scan electrode Y. More specifically, an address bias signal X-Bias may be supplied to the address electrode X during the supply of the rising signal RS of the first reset signal R1, and a ground level voltage GND may be supplied to the address electrode X during the supply of the rising signal RS of the second reset signal R2. Hence, a setup discharge generated by the rising signal RS of the first reset signal R1 may be prevented from moving toward the address electrode X. Generation of an erroneous discharge may be prevented, and generation of image sticking may be reduced.

A first sustain bias signal Vzb1 may be supplied to the sustain electrode Z during the supply of the falling signal FS of the first reset signal R1. Hence, a set-down discharge generated by the falling signal FS of the first reset signal R1 may be further stabilized. A voltage magnitude of the first sustain bias signal Vzb1 may be substantially equal to a voltage magnitude of a sustain signal SUS supplied to at least one of the scan electrode Y and the sustain electrode Z during a sustain period SP.

During an address period AP following the reset period RP, a scan bias signal Vsc having a voltage greater than minimum voltages Vmin1 and Vmin2 of the falling signals may be supplied to the scan electrode Y. A scan signal Sc falling from the scan bias signal Vsc may be supplied to the scan electrode Y.

A pulse width of a scan signal supplied to the scan electrode during an address period of at least one subfield of a plurality of subfields may be different from pulse widths of scan signals supplied during address periods of other subfields. A pulse width of a scan signal in a subfield may be greater than a pulse width of a scan signal in a next subfield in time order. For example, a pulse width of the scan signal may be gradually reduced in the order of 2.6 μs, 2.3 μs, 2.1 μs, 1.9 μs, etc., or may be reduced in the order of 2.6 μs, 2.3 μs, 2.3 μs, 2.1 μs 1.9 μs, 1.9 etc. in the successively arranged subfields.

When the scan signal Sc is supplied to the scan electrode Y, a data signal Dt corresponding to the scan signal Sc may be supplied to the address electrode X. As a voltage difference between the scan signal Sc and the data signal Dt is added to a wall voltage produced during the reset period RP, an address discharge may occur inside the discharge cells to which the data signal Dt is supplied.

During the address period AP, a second sustain bias signal Vzb2 may be supplied to the sustain electrode Z. Hence, the address discharge may occur more stably. A voltage magnitude of the second sustain bias signal Vzb2 may be less than a voltage magnitude of the first sustain bias signal Vzb1.

During a sustain period SP following the address period AP, the sustain signal SUS may be supplied to at least one of the scan electrode Y or the sustain electrode Z. FIG. 4 shows that the sustain signals SUS are alternately supplied to the scan electrode Y and the sustain electrode Z.

As a wall voltage inside the discharge cell selected by generating the address discharge is added to a voltage of the sustain signal SUS, every time the sustain signal SUS is supplied, a sustain discharge, i.e., a display discharge may occur between the scan electrode Y and the sustain electrode Z.

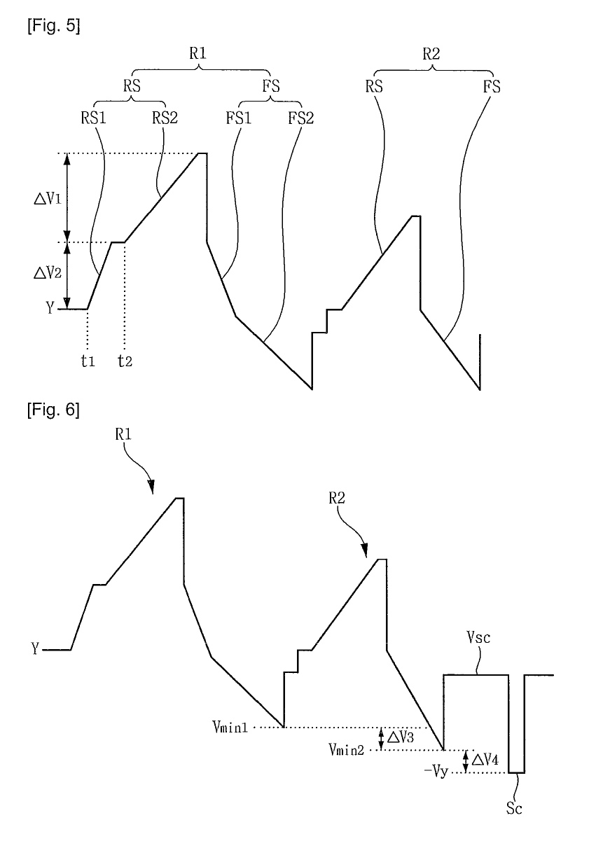

FIG. 5 illustrates configurations of first and second reset signals.

As shown in FIG. 5, a first reset signal R1 may include first and second rising signals RS1 and RS2 each having a different voltage change rate. A second reset signal R2 may follow the first reset signal R1.

The second rising signal RS2 may follow the first rising signal RS1. For example, FIG. 5 shows that the first rising signal RS1 is supplied at a time point t1 and the second rising signal RS2 is supplied at a time point t2. The voltage change rate of the first rising signal RS1 may be greater than the voltage change rate of the second rising signal RS2.

As above, when the first reset signal R1 includes the first and second rising signals RS1 and RS2 each having the different voltage change rate, a voltage level of the scan electrode Y may rapidly rise until a setup discharge starts to occurs, and the voltage level of the scan electrode Y may relatively slowly rise during generation of the setup discharge. Hence, an improvement in the contrast characteristics and a reduction in generation of bright defect may be achieved, and time required to drive the plasma display panel may sufficiently secured.

Because the setup discharge occurs during the supply of the second rising signal RS2, a voltage magnitude ΔV1 of the second rising signal RS2 may be greater than a voltage magnitude ΔV2 of the first rising signal RS1 so as to more stably generate the setup discharge. For example, if the voltage magnitude ΔV1 of the second rising signal RS2 is less than the voltage magnitude ΔV2 of the first rising signal RS1, the setup discharge is likely to occur during the supply of the first rising signal RS1.

On the contrary, the second reset signal R2 may include only one rising signal gradually rising from the ground level voltage GND.

The number of rising signals of the first reset signal R1 may be different from the number of rising signals of the second reset signal R2.

If a maximum voltage of one reset signal of the first and second reset signals R1 and R2 is greater than a maximum voltage of the other reset signal, the number of rising signals of the one reset signal may be more than the number of rising signals of the other second reset signal. For example, FIG. 5 shows that a maximum voltage of the first reset signal R1 is greater than a maximum voltage of the second reset signal R2 and the number of rising signals of the first reset signal R1 is more than the number of rising signals of the second reset signal R2.

A reason why the number of rising signals of the first reset signal R1 is more than the number of rising signals of the second reset signal R2 is that an amount of light generated by the first reset signal R1 may be more than an amount of light generated by the second reset signal R2 when the maximum voltage of the first reset signal R1 is greater than the maximum voltage of the second reset signal R2.

FIG. 6 illustrates minimum voltages of falling signals of first and second reset signals.

As shown in FIG. 6, a minimum voltage −Vy of a scan signal Sc supplied to the scan electrode Y during an address period may be less than minimum voltages Vmin1 and Vmin2 of first and second reset signals R1 and R2. Hence, an intensity of an address discharge may increase, and the address discharge may be stabilized.

If a maximum voltage of the first reset signal R1 is greater than a maximum voltage of the second reset signal R2, the minimum voltage Vmin1 of the first reset signal R1 may be greater than the minimum voltage Vmin2 of the second reset signal R2.

For example, the minimum voltage Vmin1 of the first reset signal R1 may be greater than the minimum voltage Vmin2 of the second reset signal R2 by a voltage magnitude of ΔV3, and the minimum voltage Vmin2 of the second reset signal R2 may be greater than the minimum voltage −Vy of the scan signal Sc by a voltage magnitude of ΔV4.

As above, when the minimum voltage Vmin1 of the first reset signal R1 is greater than the minimum voltage Vmin2 of the second reset signal R2, a set-down discharge generated by a falling signal of the first reset signal R1 may be further stabilized. Further, an intensity of the set-down discharge generated by the falling signal of the first reset signal R1 may be prevented from excessively increasing. Hence, the contrast characteristics may be improved.

More specifically, if the minimum voltage Vmin1 of the first reset signal R1 is equal to or less than the minimum voltage Vmin2 of the second reset signal R2 when the maximum voltage of the first reset signal R1 is greater than the maximum voltage of the second reset signal R2, the intensity of the set-down discharge generated by the falling signal of the first reset signal R1 may excessively increase. Therefore, the minimum voltage Vmin1 of the first reset signal R1 may be greater than the minimum voltage Vmin2 of the second reset signal R2, so as to prevent the intensity of the set-down discharge generated by the falling signal of the first reset signal R1 from excessively increasing.

FIG. 6 shows that the maximum voltage of the first reset signal R1 is greater than the maximum voltage of the second reset signal R2 and the minimum voltage Vmin1 of the first reset signal R1 is greater than the minimum voltage Vmin2 of the second reset signal R2. However, when the maximum voltage of the first reset signal R1 is less than the maximum voltage of the second reset signal R2, the minimum voltage Vmin1 of the first reset signal R1 may be less than the minimum voltage Vmin2 of the second reset signal R2.

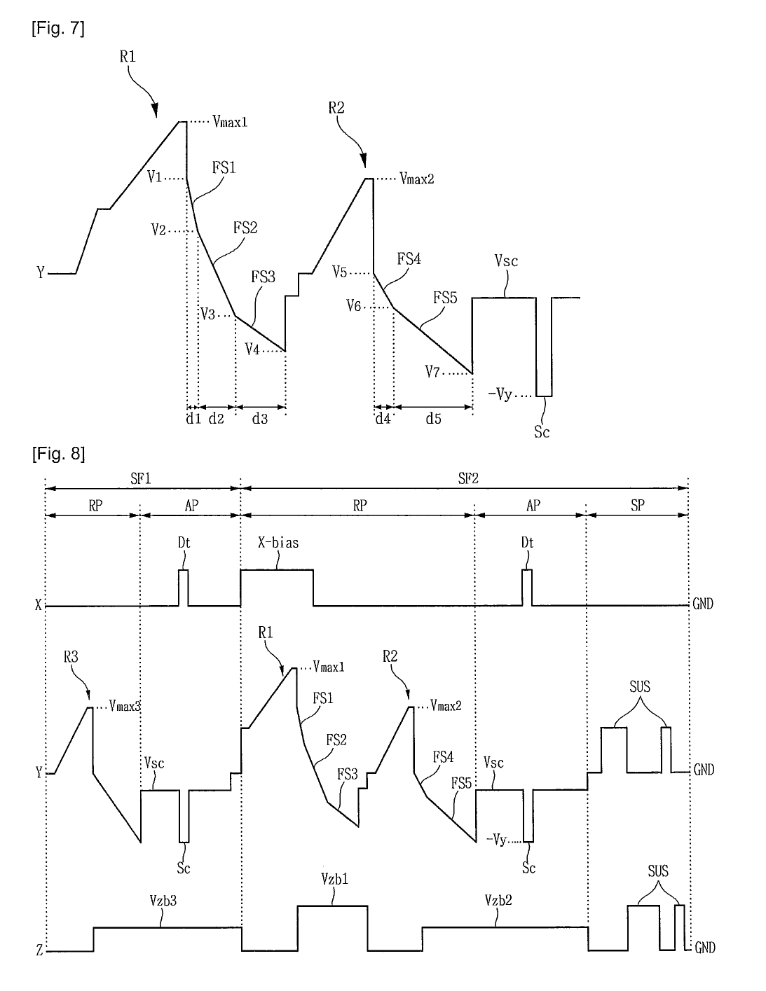

FIG. 7 illustrates a configuration of a falling signal.

As shown in FIG. 7, a first reset signal R1 may sequentially include first, second, and third falling signals FS1, FS2, and FS3 each having a different voltage change rate, and a second reset signal R2 may sequentially include fourth and fifth falling signals FS4 and FS5 each having a different voltage change rate.

The voltage change rate of the first falling signal FS1 may be greater than the voltage change rate of the second falling signal FS2, and the voltage change rate of the second falling signal FS2 may be greater than the voltage change rate of the third falling signal FS3.

When the first falling signal FS1 is supplied to the scan electrode Y, a setup discharge generated by a rising signal of the first reset signal R1 prior to the first falling signal FS1 may be fully initialized.

Subsequently, when the second falling signal FS2 is supplied to the scan electrode Y, the second falling signal FS2 may be used to initialize the setup discharge. Further, the second falling signal FS2 may stabilize a set-down discharge to thereby prevent generation of a bright defect.

A length d2 of a supply period of the second falling signal FS2 may be approximately 1.1 to 1.9 times or 1.3 to 1.8 times a length d1 of a supply period of the first falling signal FS1, so as to further stabilize the set-down discharge during the supply of the first and second falling signals FS1 and FS2.

Subsequently, when the third falling signal FS3 is supplied to the scan electrode Y, the third falling signal FS3 may fully stabilize a set-down discharge to thereby prevent generation of a bright defect.

A length d3 of a supply period of the third falling signal FS3 may be approximately 0.7 to 1.4 times or 0.85 to 1.3 times the length d2 of the supply period of the second falling signal FS2, so as to further stabilize the set-down discharge during the supply of the third falling signal FS3.

The voltage change rate of the fourth falling signal FS4 may be greater than the voltage change rate of the fifth falling signal FS5. Hence, a set-down discharge generated by the falling signals of the second reset signal R2 may be further initialized. A length d5 of a supply period of the fifth falling signal FS5 may be approximately 1.6 to 3.7 times or 2.0 to 3.4 times a length d4 of a supply period of the fourth falling signal FS4, so as to further stabilize the set-down discharge during the supply of the fourth and fifth falling signals FS4 and FS5.

In the first reset signal R1, the first falling signal FS1 may gradually fall from a first voltage V1 less than a maximum voltage Vmax1 of the first reset signal R1 to a second voltage V2 greater than the ground level voltage GND. The second falling signal FS2 may gradually fall from the second voltage V2 to a third voltage V3 less than the ground level voltage GND. The third falling signal FS3 may gradually fall from the third voltage V3 to a fourth voltage V4.

In the second reset signal R2, the fourth falling signal FS4 may gradually fall from a fifth voltage V5, that is less than the second voltage V2 and greater than the third voltage V3, to a sixth voltage V6. The fifth falling signal FS5 may gradually fall from the sixth voltage V6 to a seventh voltage V7.

The fifth voltage V5 may be substantially equal to the ground level voltage GND. The seventh voltage V7 may be less than the fourth voltage V4. The fourth and seventh voltages V4 and V7 may be greater than a minimum voltage −Vy of a scan signal Sc.

As above, the intensity of the set-down discharge may be prevented from excessively increasing by differently setting voltage ranges of the falling signals. Hence, the set-down discharge may be further stabilized.

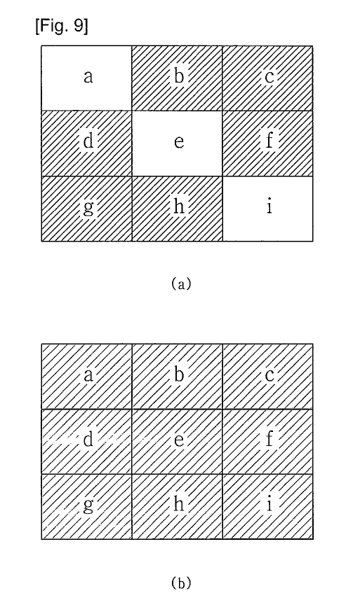

FIG. 8 illustrates a method of driving a plasma display panel according to an exemplary embodiment. Since a configuration of a plasma display panel shown in FIG. 8 is substantially the same as the plasma display panel described above, a further description may be briefly made or may be entirely omitted.

As shown in FIG. 8, a third reset signals R3 may be supplied to the scan electrode Y during a reset period RP of a first subfield SF1 of a plurality of subfields of a frame. The third reset signals R3 may one rising signal and one falling signal.

During a portion of the reset period RP and an address period AP of the first subfield SF1, a third sustain bias signal Vzb3 may be supplied to the sustain electrode Z. A voltage magnitude of the third sustain bias signal Vzb3 may be substantially equal to a voltage magnitude of the second sustain bias signal Vzb2 in a second subfield SF2.

A reset period RP of the second subfield SF2 may follow the address period AP of the first subfield SF1. In other words, because a sustain period is omitted in the first subfield SF1, there is no sustain signal supplied in the first subfield SF1.

The first subfield SF1 may be a half gray level subfield not to generate a sustain discharge.

Since the second subfield SF2 following the first subfield SF1 is described above, a further description may be briefly made or may be entirely omitted. During the reset period RP of the second subfield SF2, first and second reset signals R1 and R2 may be supplied to the scan electrode Y. A reason why the plurality of reset signals are supplied during the reset period RP of the second subfield SF2 following the half gray level first subfield SF1 is that a sustain discharge does not occur in the first subfield SF1.

More specifically, because the sustain discharge does not occur in the first subfield SF1, a distribution state of wall charges during the address period AP of the first subfield SF1 may remain in the reset period RP of the second subfield SF2. During the address period AP, there is a great difference between a discharge cell to generate an address discharge and a discharge cell not to generate an address discharge in an amount of wall charges and a distribution state of the wall charges. Therefore, the plurality of reset signals may be supplied during the reset period RP of the second subfield SF2, so as to reduce the difference in the amount of wall charges and the distribution state of the wall charges.

FIG. 9 is a diagram for explaining a reason why a sustain period is omitted in a first subfield.

It is assumed that one sustain signal is respectively supplied to the scan electrode Y and the sustain electrode Z during a sustain period. In this case, an amount of light generated during a reset period, an address period, and the sustain period may be added to achieve a gray level.

It is assumed that a gray level of light generated by one sustain signal (i.e., a gray level of light achieved by a sustain discharge) is 0.5 and a gray level of light generated by a data signal and a scan signal (i.e., a gray level of light achieved by an address discharge) is 0.5. Light generated during the reset period is negligible. The assumptions are voluntarily set for the convenience of explanation.

If an image with 0.5 gray level is to be displayed in an area comprised of 3×3 discharge cells “a” to “i”, as shown in (a) of FIG. 9, the three discharge cells a, e, and i have to be turned on. A gray level of light generated in the area comprised of the 9 discharge cells “a” to “i” is 4.5 (=1.5×3). It may be perceived that a gray level of the image achieved by each of the 9 discharge cells is 0.5. However, in a method illustrated in (a) of FIG. 9, a deterioration in the image quality, for example, a specific pattern on the screen may be caused.

On the other hand, if the sustain period is omitted in the first subfield SF1 as in FIG. 8, a representable gray level in the first subfield (i.e., a gray level of light achieved by an address discharge) is 0.5.

If an image with 0.5 gray level is to be displayed in an area comprised of 3×3 discharge cells “a” to “i”, as shown in (b) of FIG. 9, all the 9 discharge cells “a” to “i” have to be turned on. Hence, in a method illustrated in (b) of FIG. 9, because a specific pattern is not displayed on the screen, the image quality may be improved. Further, a gray level may be finely represented.

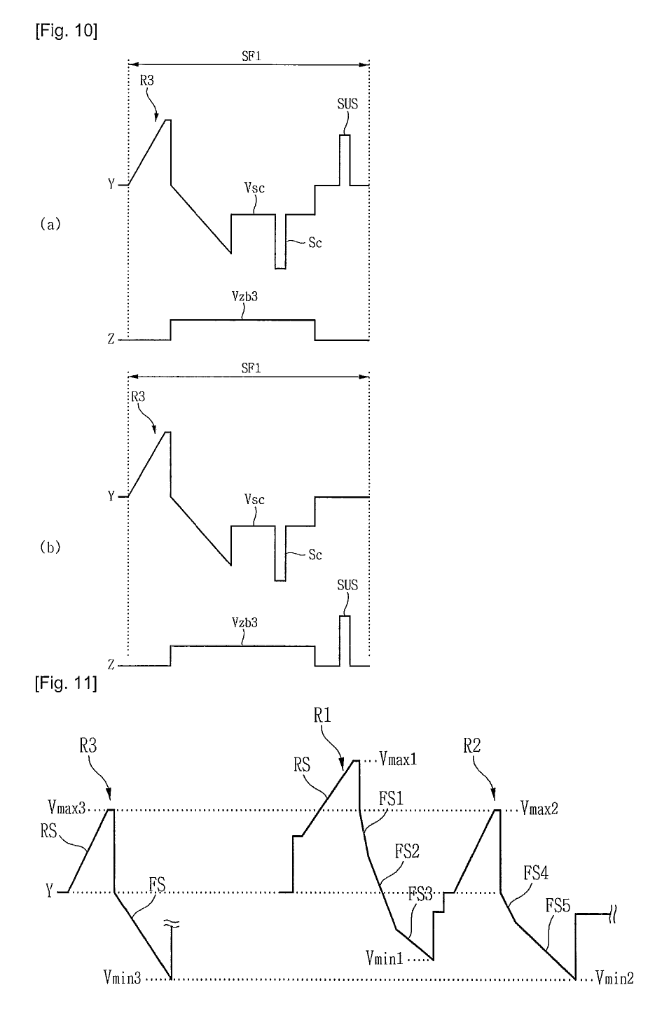

FIG. 10 shows that a sustain signal is not supplied to one of a scan electrode and a sustain electrode during a sustain period.

More specifically, (a) of FIG. 10 shows that a sustain signal SUS is supplied to the scan electrode Y and is not supplied to the sustain electrode Z during a sustain period of a first subfield SF1. (b) of FIG. 10 shows that a sustain signal SUS is not supplied to the scan electrode Y and is supplied to the sustain electrode Z during a sustain period of a first subfield SF1.

As shown in FIG. 10, a subfield, in which a sustain signal is supplied to one of the scan electrode Y and the sustain electrode Z and is not supplied to the other electrode, may be a half gray level subfield.

FIG. 11 is a diagram for comparing first, second, and third reset signals.

A maximum voltage of a third reset signal R3 supplied in a first subfield may be substantially equal to a maximum voltage of one of first and second reset signals R1 and R2 supplied in a second subfield. For example, FIG. 11 shows that a maximum voltage Vmax3 of the third reset signal R3 is substantially equal to a maximum voltage Vmax2 of the second reset signal R2 that is less than a maximum voltage Vmax1 of the first reset signal R1.

If the maximum voltage Vmax2 of the second reset signal R2 is greater than the maximum voltage Vmax1 of the first reset signal R1, the maximum voltage Vmax3 of the third reset signal R3 may be substantially equal to the maximum voltage Vmax1 of the first reset signal R1.

Because the first subfield is a half gray level subfield achieving a low gray level, the maximum voltage Vmax3 of the third reset signal R3 may be substantially equal to the maximum voltage Vmax2 of the second reset signal R2 that is less than the maximum voltage Vmax1 of the first reset signal R1. In other words, because a relatively small amount of light has to be generated in the first subfield so as to finely achieve the gray level in the first subfield, an amount of light generated during the reset period of the first subfield may be reduced by reducing the maximum voltage Vmax3 of the third reset signal R3 supplied in the first subfield.

Further, the maximum voltage of one of the first and second reset signals R1 and R2 may be greater than the maximum voltage Vmax3 of the third reset signal R3, so as to stabilize a reset discharge in the second subfield. FIG. 11 shows that the maximum voltage Vmax1 of the first reset signal R1 is greater than the maximum voltage Vmax3 of the third reset signal R3.

The number of falling signals of the third reset signal R3 may be less than the number of falling signals of the first reset signal R1 and the number of falling signals of the second reset signal R2, so as to simplify a drive of the plasma display panel in the first subfield.

A different between the maximum voltage Vmax3 and a minimum voltage Vmin3 of the third reset signal R3 may be substantially equal to a different between the maximum voltage and a minimum voltage of one reset signal when the maximum voltage of the one reset signal of the first and second reset signals R1 and R2 is less than the maximum voltage of the other reset signal. FIG. 11 shows that a different between the maximum voltage Vmax3 and the minimum voltage Vmin3 of the third reset signal R3 is substantially equal to a different between the maximum voltage Vmax2 and a minimum voltage Vmin2 of the second reset signal R2.

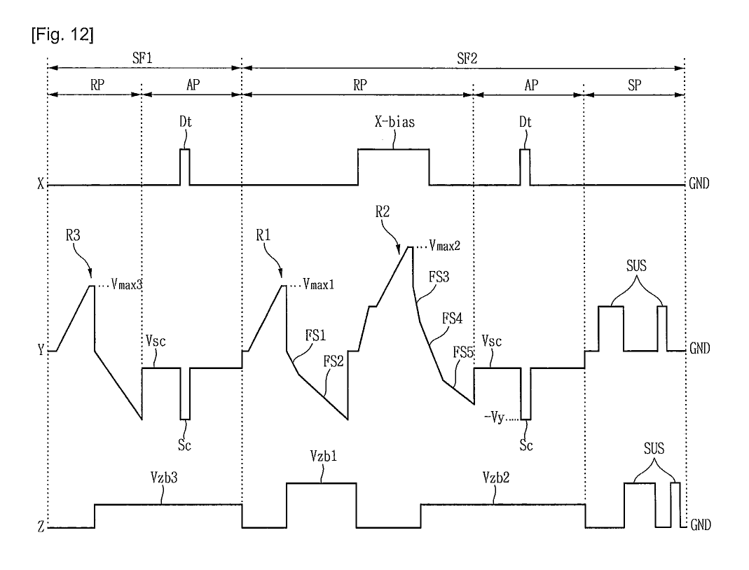

FIG. 12 shows that a maximum voltage of a second reset signal is greater than a maximum voltage of a first reset signal.

As shown in FIG. 12, a maximum voltage Vmax1 of a first reset signal R1 may be less than a maximum voltage Vmax2 of a second reset signal R2 following the first reset signal R1, unlike the case illustrated in FIG. 11.

The ground level voltage may be supplied to the address electrode X during the supply of a rising signal of the first reset signal R1, and an address bias signal X-Bias may be supplied to the address electrode X during the supply of a rising signal of the second reset signal R2.

The number of falling signals of the second reset signal R2 is more than the number of falling signals of the first reset signal R1.

Since the method of driving the panel illustrated in FIG. 12 is substantially the same as that illustrated in FIG. 8 except configuration of the first and second reset signals, a further description is omitted. The configurations of the first and second reset signals in FIG. 12 are opposite to those of the signals in FIG. 11.

1. A method of driving a plasma display panel including a scan electrode and a sustain electrode positioned substantially parallel to each other and an address electrode crossing the scan electrode and the sustain electrode, the method comprising:
supplying a first reset signal to the scan electrode during a reset period of at least one of a plurality of subfields of a frame; and
supplying a second reset signal following the first reset signal to the scan electrode,
wherein the first and second reset signals each include a rising signal with a gradually rising voltage and a falling signal with a gradually falling voltage, wherein the number of falling signals of the first reset signal is different from the number of falling signals of the second reset signal.

2. The method of claim 1, wherein at least one of the first and second reset signals includes a plurality of falling signals each having a different voltage change rate.

3. The method of claim 1, wherein a maximum voltage of the first reset signal is greater than a maximum voltage of the second reset signal, wherein the number of falling signals of the first reset signal is more than the number of falling signals of the second reset signal.

4. The method of claim 1, wherein a maximum voltage of the second reset signal is greater than a maximum voltage of the first reset signal, wherein the number of falling signals of the second reset signal is more than the number of falling signals of the first reset signal.

5. The method of claim 1, further comprising supplying a scan signal to the scan electrode during an address period following the reset period, wherein minimum voltages of the falling signals of the first and second reset signals are greater than a minimum voltage of the scan signal.

6. The method of claim 1, wherein a maximum voltage of the first reset signal is greater than a maximum voltage of the second reset signal, wherein a minimum voltage of the first reset signal is greater than a minimum voltage of the second reset signal.

7. The method of claim 1, wherein a maximum voltage of the second reset signal is greater than a maximum voltage of the first reset signal, wherein a minimum voltage of the second reset signal is greater than a minimum voltage of the first reset signal.

8. The method of claim 1, wherein a maximum voltage of one reset signal of the first and second reset signals is greater than a maximum voltage of the other reset signal,
wherein a voltage of the address electrode during the supply of the rising signal of the one reset signal is greater than a voltage of the address electrode during the supply of the rising signal of the other reset signal.

9. The method of claim 1, wherein the first reset signal sequentially includes first, second, and third falling signals each having a different voltage change rate, the voltage change rate of the second falling signal is less than the voltage change rate of the first falling signal, and the voltage change rate of the third falling signal is less than the voltage change rate of the second falling signal, wherein the second reset signal sequentially includes fourth and fifth falling signals each having a different voltage change rate, and the voltage change rate of the fifth falling signal is less than the voltage change rate of the fourth falling signal.

10. The method of claim 9, wherein the first falling signal gradually falls from a first voltage less than a maximum voltage of the first reset signal to a second voltage greater than a ground level voltage,
wherein the second falling signal gradually falls from the second voltage to a third voltage less than the ground level voltage,
wherein the third falling signal gradually falls from the third voltage to a fourth voltage,
wherein the fourth falling signal gradually falls from a fifth voltage, that is less than the second voltage and greater than the third voltage, to a sixth voltage,
wherein the fifth falling signal gradually falls from the sixth voltage to a seventh voltage.

11. The method of claim 10, wherein the seventh voltage is less than the fourth voltage.

12. The method of claim 10, wherein a length of a supply period of the second falling signal is approximately 1.1 to 1.9 times a length of a supply period of the first falling signal.

13. The method of claim 10, wherein a length of a supply period of the third falling signal is approximately 0.7 to 1.4 times a length of a supply period of the second falling signal.

14. The method of claim 1, wherein the number of rising signals of the first reset signal is different from the number of rising signals of the second reset signal.

15. The method of claim 14, wherein a maximum voltage of one reset signal of the first and second reset signals is greater than a maximum voltage of the other reset signal,
wherein the number of rising signals of the one reset signal is more than the number of rising signals of the other reset signal.

16. A method of driving a plasma display panel including a scan electrode and a sustain electrode positioned substantially parallel to each other and an address electrode crossing the scan electrode and the sustain electrode, the method comprising:
allowing a sustain signal not to be supplied to at least one of the scan electrode and the sustain electrode during a sustain period of a first subfield of a plurality of subfields of a frame, or omitting a sustain period in the first subfield;
supplying a first reset signal to the scan electrode during a reset period of a second subfield following the first subfield; and
supplying a second reset signal following the first reset signal to the scan electrode,
wherein the first and second reset signals each include a rising signal with a gradually rising voltage and a falling signal with a gradually falling voltage, wherein the number of falling signals of the first reset signal is different from the number of falling signals of the second reset signal.

17. The method of claim 16, further comprising supplying a third reset signal to the scan electrode during a reset period of the first subfield,
wherein the third reset signal includes a rising signal with a gradually rising voltage and a falling signal with a gradually falling voltage,
wherein the number of falling signals of the third reset signal is less than the number of falling signals of the first reset signal and the number of falling signals of the second reset signal.

18. The method of claim 17, wherein a maximum voltage of the first reset signal is greater than a maximum voltage of the second reset signal, wherein the number of falling signals of the first reset signal is more than the number of falling signals of the second reset signal.

19. The method of claim 18, wherein the maximum voltage of at least one of the first and second reset signals is greater than a maximum voltage of the third reset signal.

20. The method of claim 16, wherein a maximum voltage of one reset signal of the first and second reset signals is greater than a maximum voltage of the other reset signal,
wherein a difference between a maximum voltage and a minimum voltage of the third reset signal is substantially equal to a difference between a maximum voltage and a minimum voltage of the other reset signal.
